(19) United States
(12) Patent Application Publication
(10) Pub. No.: US 2017/0121075 A1
(43) Pub. Date: May 4, 2017

(54) MAGNETIC MEASURING DEVICE AND CONTAINER

(71) Applicant: Mead Johnson Nutrition Company, Glenview, IL (US)

(72) Inventors: Juan M. Gonzalez, Newburgh, IN (US); Margo E. Love, Evansville, IN (US)

(21) Appl. No.: 14/930,059

(22) Filed: Nov. 2, 2015

(51) Int. Cl. B65D 51/24; B65D 83/06; G01F 19/00; A47G 19/34

(52) U.S. Cl. CPC B65D 51/246; A47G 19/34; B65D 83/06; G01F 19/002

(57) ABSTRACT

A scoop for dispensing particulate material. The scoop includes a bucket and a magnetic handle. The scoop may magnetically couple with a metallic seal, a container sidewall, or a closure. In one embodiment, the handle may be constructed of magnetic materials, such as ferromagnetic powder. In another embodiment, the handle may include a magnetic strip thereon. The scoop may be combined with an associated container, such that the scoop is used to dispense particulate material from the container.

### TECHNICAL FIELD

The present disclosure relates to a measuring device for measuring and dispensing particulate material, such as infant formula, and an associated container having a closure with a dock for the measuring device. More specifically, the disclosure is directed to a scoop, container and closure, wherein the scoop is magnetically coupled with a dock on the closure or directly with the container.

### BACKGROUND

There are many products in particulate form that are currently stored and sold in containers. These products include infant formula, flour, coffee, sugar and nutritional supplements, such as protein or dietary supplements. Measuring devices may be included with these products and containers. These measuring devices are often positioned with the product within the container, and, in many instances, added to a container prior to filling the container with product.

Measuring devices formed of plastic are often used to dispense and measure various particulate materials, particularly in the industrial, food and pharmaceutical sectors. One problem often associated with such measuring devices is that they become mixed within their accompanying product, resulting in the end-user searching through the product to locate and use the measuring device. As such, their use may result in contamination of the product. For example, a user may use his/her hands to locate the measuring device in the product, and/or place the measuring device on an unclean surface before returning it to the container, causing contamination or cross contamination of the product.

Accordingly, there exists a need for a scoop that may be conveniently stored with the container that contains product without being intermixed with the product. Moreover, the scoop should be user-friendly for the ultimate consumer. A user-friendly scoop is one that is ergonomic, convenient for the ultimate user to store, use and from which to scoop, measure and dispense the accompanying product.

### BRIEF SUMMARY

The present application discloses a user-friendly magnetic scoop that can be conveniently stored with an associated container. The scoop is for particulate material, and comprises a bucket and a handle. Various embodiments exist for rendering the scoop magnetic. The scoop may, in some embodiments, include a magnetic strip on the handle of the scoop so that the handle is magnetic. The magnetic strip may be oriented along, or perpendicular to, a longitudinal axis of the handle. In an alternate embodiment, the handle may be comprised of a polymeric material having at least one ferromagnetic powder admixed therein. The ferromagnetic powder may be, for example, ferrite powder, ilmenite powder, neodymium, or a combination thereof. The polymeric material may be at least one organic polymer, such as a non-metallic organic polymer.

In some embodiments, the scoop may be coupled with a container. In other embodiments, the scoop may be associated with a container and/or a closure. The scoop may magnetically couple with the closure. For example, the closure may be metallic and include an underside that is configured to be magnetically coupled with the magnetic scoop. In an embodiment, the scoop is magnetically coupled with a docking magnet in a closure. In another embodiment, the scoop may be magnetically coupled to a magnetic dock in a closure. The dock may comprise a dock magnet to attract and magnetically couple with the magnetic scoop. The scoop may have a free position in which the scoop is not coupled with the dock and a docketed position in which the scoop is magnetically coupled with the dock. In yet another embodiment, the container may comprise a metallic sidewall, and the scoop may be magnetically coupled with the metallic sidewall.

In an embodiment, the container includes a metallic foil seal across a top aperture, and the magnetic scoop may be magnetically coupled with the metallic seal.

The magnetic scoop includes a handle and a bucket having an exterior surface, a diameter, and a tapered tip in certain embodiments. The tapered tip may extend outward from the exterior surface of the bucket in a range of from about 10% to about 30% of the diameter of the bucket. In an embodiment, the tapered tip may have a profile defined by a circle having a diameter in a range of from 60% to 80% of the bucket diameter. In still another embodiment, the bucket may have a depth of from about 75% to about 250% of the diameter of the bucket.

In an embodiment, the bucket may have a rim defined by a circumference of a top of the bucket, and the tapered tip may curve outward from the rim oppositely from the handle.

### BRIEF DESCRIPTION OF THE DRAWINGS

FIG. 1 is an elevation view of an embodiment of a magnetic scoop.

FIG. 2A is a top view of an embodiment of a magnetic scoop.

FIG. 2B is a top view of another embodiment of a magnetic scoop.

FIG. 3A is a perspective view of still another embodiment of a magnetic scoop.

FIG. 3B is a perspective view of an embodiment of a magnetic scoop.

FIG. 4 a perspective view of yet another embodiment of a magnetic scoop.

FIG. 5 is an elevation view of an embodiment of a magnetic scoop associated with a container.

FIG. 6 is an elevation view of another embodiment of a magnetic scoop associated with a container.

FIG. 7 is a prospective view of an embodiment of a magnetic scoop associated with a container and a closure.

FIG. 8 is a prospective view of another embodiment of a magnetic scoop associated with a container and a closure.

FIG. 9 is a prospective view of still another embodiment of a magnetic scoop associated with a container and a closure.

### DETAILED DESCRIPTION

While the making and using of various embodiments of the present invention are discussed in detail below, it should be appreciated that the present invention provides many applicable inventive concepts that is embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

As described herein, an upright position is considered to be the position of apparatus components while in proper operation or in a natural resting position as described herein. Vertical, horizontal, above, below, side, top, bottom and other orientation terms are described with respect to this upright position during operation unless otherwise specified. The term “when” is used to specify orientation for relative positions of components, not as a temporal limitation of the claims or apparatus described and claimed herein unless otherwise specified. The term “lateral” denotes a side to side direction when facing the “front” of an object.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

“Magnetic,” as used herein, means exhibiting properties of magnetism, such as attracting iron-containing objects. Specifically, “magnetism” refers to the physical phenomenon produced by the motion of electric charge, resulting in attractive and repulsive forces between objects. A “magnet” refers to an object made from a material that is magnetized and creates its own persistent magnetic field, such as a refrigerator magnet. As used herein, a magnet pulls on other ferromagnetic materials, such as iron, and attracts or repels other magnets. A magnet may be constructed of, for example, iron, nickel, cobalt and rare earth metal alloys.

“Scoop,” as used herein, means a ladle, or ladle-like, utensil for scooping, measuring and/or dispensing. The bowl portion of the scoop is referred to as a “bucket,” and the handle portion of the scoop is referred to as a “handle.” The bucket may be understood to be an open-top bowl. The handle may be integrally formed with the bucket.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the apparatuses and/or methods disclosed and claimed herein may be made and/or executed without undue experimentation in light of the present disclosure. While the apparatuses and methods of this invention have been described in terms of the embodiments included herein, it will be apparent to those of ordinary skill in the art that variations may be applied to the apparatuses and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

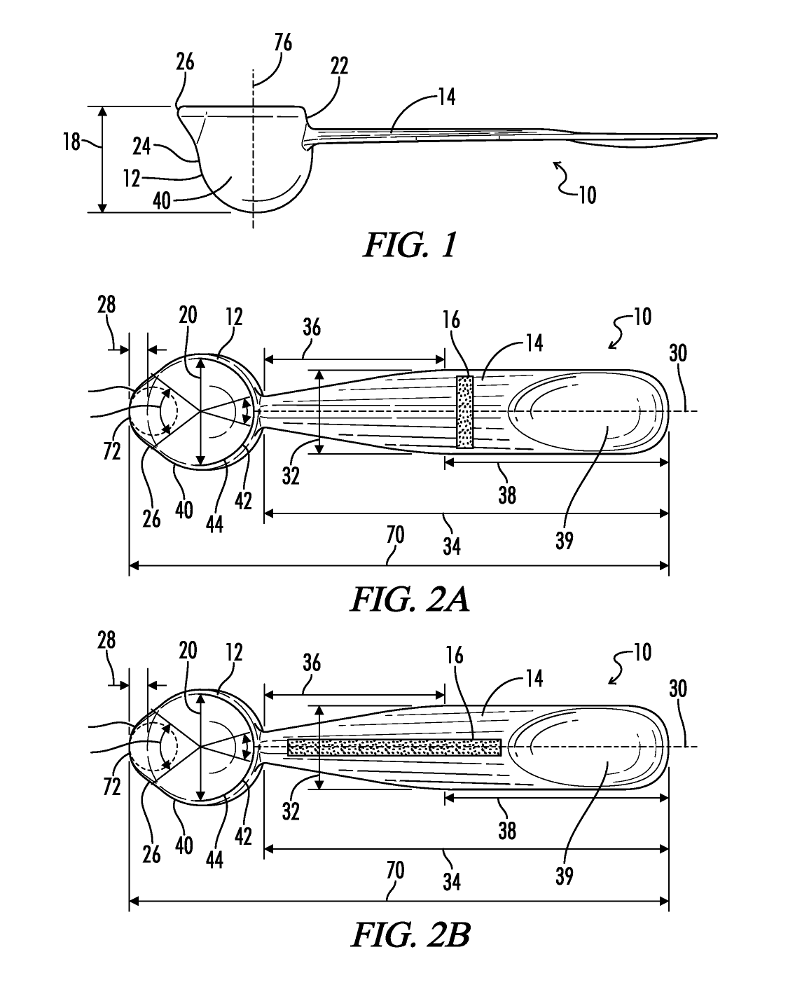

A perspective view of a scoop in accordance with the present disclosure is shown in FIG. 1 as scoop 10. Scoop 10 is configured to magnetically couple with a container 50 and is intended to dispense and measure particulate material, particularly powdered infant formula. Scoop 10 includes a bucket 12 and a handle 14. Scoop 10 may be positioned, or magnetically coupled, above the particulate material stored in the container 50, providing an end-user convenient access to scoop 10. “Particulate material” means a material that is comprised of small, separate particles, such as products that are granulated, granular, powder, powdered, etc. In an embodiment, the particulate material is an infant formula, a nutritional supplement, a nutritional fortifier, or a nutritional composition for children. The particulate material may be reconstitutable with the addition of water or milk.

Scoop 10 may be comprised of, or formed of, a polymeric material, ferromagnetic powder, or a combination thereof. In some embodiments, the polymeric material may be an organic polymer or a non-metallic organic polymer. In other embodiments, the polymeric material may be admixed, or blended, with ferromagnetic powder. The ferromagnetic powder may comprise, for example, ferrite powder, ilmenite powder, neodymium iron boron, or a combination thereof. Additional examples of suitable magnetic powders will be apparent to the skilled artisan.

In an embodiment, the ferromagnetic powder(s) renders scoop 10 magnetic. Magnetic scoop 10 must have sufficiently strong magnetism to hold a position on the object with which it is coupled, such as a metallic container sidewall, metallic lid, metallic film seal, or dock magnet. In another embodiment, scoop 10 has a magnetic handle 14 and a non-magnetic bucket 12. In still another embodiment, both handle 14 and bucket 12 are magnetic.

In an embodiment, illustrated with respect to FIGS. 2A and 2B, handle 14 has a strip magnetic 16. Strip magnet 16 may be attached to, formed with, laminated on, adhered on, or connected with handle 14. Strip magnet 16 may be constructed of at least one ferromagnetic material. In an embodiment, strip magnet 16 is a film of at least one ferromagnetic material. Strip magnet 16 may be oriented along a longitudinal axis 30 of handle 14, as shown in FIG. 2A, or oriented perpendicularly to longitudinal axis 30, as shown in FIG. 2B. Strip magnet 16 may also be oriented diagonally to longitudinal axis 30 (not shown). In use, handle 14, having strip magnet 16 positioned thereon, allows magnetic scoop 10 to magnetically couple to the intended object, such as a metallic container sidewall, metallic lid, metallic film seal, or dock magnet.

Strip magnet 16 may entirely or partially span handle width 32 or handle length 34. In some embodiments, strip magnet 16 spans from 0% to about 100%, from about 20% to about 90%, or from about 50% to about 80% of handle width 32. In yet other embodiments, strip magnet 16 spans from 0% to about 100%, from about 20% to about 80%, or from about 30% to about 70% of handle length 34. As measured in magnetic induction, the strength of the magnetic field at the surface of strip magnetic 16 may be, for example, between about 1 and about 15 millitesla (mT).

In an embodiment, handle 14 has a tapered base portion 32 and a substantially straight arm portion 38 that increase ergonomics of handle 14. Handle 14 may have a surface indentation 39. Surface indentation 39 increases ergonomics of scoop 10, because it provides an indentation for an end-user's finger for increased grip in use of scoop 10. In addition, surface indentation 39 can increase structural integrity of handle 14.

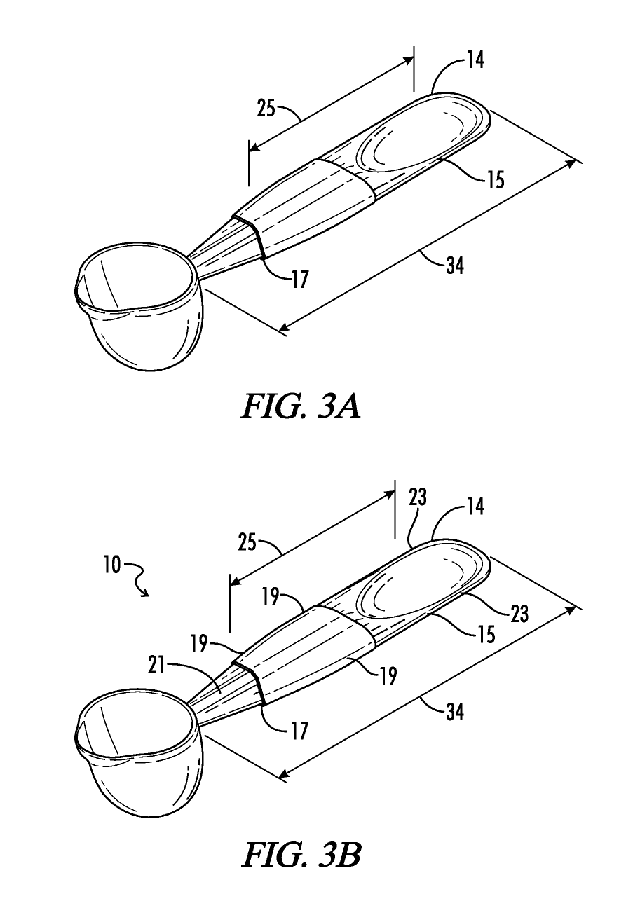

As shown in FIGS. 3A and 3B, handle 14 may have a band 15 disposed thereon. Band 15 may be, for example, disposed around handle 14. Band 15 may be constructed of at least one magnetic metallic material, such as steel, and/or include at least one ferromagnetic powder. Band 15 may extend a band length 25 that is equal to or lesser than handle length 34. Band length 25 may be in a range of from about 20% to about 100% of handle length 34. Band 15 may comprise a cylindrical exterior band wall 17. As shown in FIG. 3B, band 15 may comprise at least one flat band wall side 19. The least one flat band sidewall 19 may be three flat band sidewalls, one positioned parallel to handle top 21, and two positioned on each handle side 23. Band 15 may be constructed of a ferromagnetic material, such as stainless steel. Band 15 may magnetically couple with magnetic dock 78. In use, band 15 enables handle 14 to magnetically couple with an object, such as a metallic container sidewall, metallic lid, metallic film seal, or dock magnet.

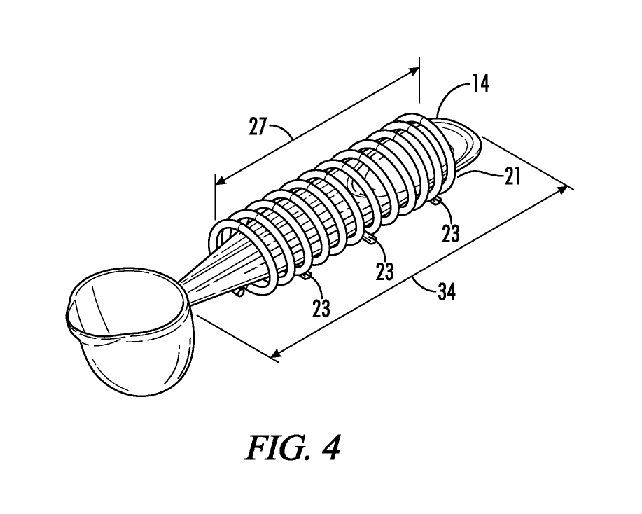

As shown in FIG. 4, handle 14 may have a spring 21 disposed thereon. Spring 21 may be constructed of a magnetic metallic material and/or include at least one ferromagnetic powder. Spring 21 may be placed on handle 14 by being expanded and slid onto handle 14. Spring 21 may have a spring length 27 that is equal to or less than handle length 34. Spring length may be from about 20% to about 100% of handle length 34. In an embodiment, handle 14 has at least one cam 23 to retain the spring around handle 14. Spring 21 may magnetically couple with magnetic dock 78. In a further embodiment, band 15 and/or spring 21 cannot be easily removed from handle 14 to prevent band 15 or spring 21 from being removed from handle and swallowed.

In another embodiment, scoop 10 includes a tapered tip 26 formed on distal side 24 of bucket 12, tapered tip 26 being longitudinally aligned with handle 14. Tapered tip 26 has a tip radius 28, preferably no greater than 10 mm, more preferably from about 2 mm to about 8 mm, most preferably about 4 mm to about 6 mm.

Tapered tip 26 may be described as having a profile 72 defined by a circle 74 having a diameter in a range of from 60% to 80% of outside bucket diameter 20. Tapered tip 26 can curve outward from bucket 12 so that the curve is defined by the profile of circle 74. Circle 74 can be centered with or variably off-set from center axis 76 of bucket 12. Further, the greater circle 74 is off-set from center axis 76, the more tapered tip 26 protrudes and curves continuously outward relative to center axis 76 of bucket 12. Circle 74 may pass through central axis 76 of bucket 12. The diameter of circle 74 may be varied in a range of from 60% to 80% of outside bucket diameter 20 as to vary the relative shape and size of tapered tip 26 as compared to bucket 12.

The longitudinal alignment of tapered tip 26 with handle 14 increases ergonomics and makes more convenient, efficient and effective the measuring, dispensing and scooping actions of the scoop 10.

Bucket 12 has a cylindrical exterior surface 40. Tapered tip 26 may extend outward from exterior surface 40 in a range of from about 10% to about 30% of the diameter of the bucket. The outward extension of tapered tip 26 of from about 10% to about 30% of the diameter of bucket 12 increases the convenience, efficiency and effectiveness with which the end-user may scoop, measure and dispense the particulate material.

Bucket 12 may have a bucket interior 42 having a volume of from about 5 cubic centimeters to about 30 cubic centimeters, preferably from about 10 cubic centimeters to about 25 cubic centimeters. The bucket volume and depth may be varied according to the amount of particulate material to be dispensed.

Bucket 12 has a circumference 44 extending 360 degrees around it. Handle 14 may circumscribe a handle angle 46 from about 10 degrees to about 60 degrees of bucket circumference 44, and tapered tip 26 may circumscribe a bucket angle 48 from about 50 degrees to about 90 degrees of bucket circumference 44. In a preferred embodiment, handle 14 may circumscribe an angle 46 from about 10 degrees to about 30 degrees of bucket circumference 44, and tapered tip 26 may circumscribe an angle 48 from about 60 degrees to about 80 degrees of bucket circumference 44. The disclosed degree that tapered tip 26 and handle 14 circumscribe around bucket 12 increases the structural integrity of scoop 10 while increasing the efficacy with which the end-user can scoop, measure and dispense the particulate material.

Bucket 12 has an outside diameter 20, and bucket 12 has a depth 18 in a range of from about 75% to about 250% of the outside diameter 20 of bucket 12. The outside diameter 20 and depth 18 relate to the amount of particulate material bucket 12 is able to hold, which may be adjusted according to the amount of particulate material to be scooped, measured and dispensed. Bucket 14 has a handle side 22 and an oppositely facing distal side 24. Scoop 10 has a handle 14 connected, in some embodiments, integrally connected, to handle side 22 of the bucket 12. Handle 14 may be used by the end-user of scoop 10 to hold the scoop 10. Handle 14 may be ergonomic for ease in the scooping, measuring and dispensing of the particulate material.

In an embodiment, bucket 12 is adapted to scoop, measure and dispense the particulate material stored in container 50. In an embodiment, container 50 has a height 68 and scoop 10 has a maximum length 70 of from about 50% to about 110% height 68 of container 50. Maximum length 108 may be varied according to the height of container 50 so that scoop 10 can be efficiently, effectively and ergonomically used by the end-user to scoop, measure and dispense the particulate material from container 50. Maximum length 108 may be varied such that it is easy for the end-user to scoop from the bottom on the container.

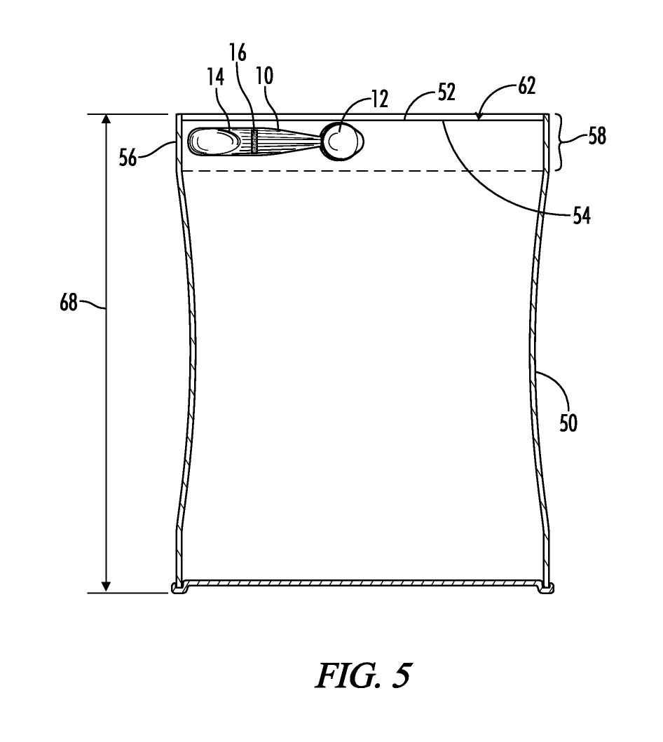

In FIG. 5, scoop 10 is associated with a container 50. Container 50 may be metallic. For example, container 50 may be constructed of a steel alloy. Container 50 has a sidewall 56. Sidewall 56 may have at least one substantially straight portion 58. Substantially straight portion 58 may be at the top of container 50. Scoop 10 may magnetically couple with sidewall 56 and/or with at least one substantially straight portion 58.

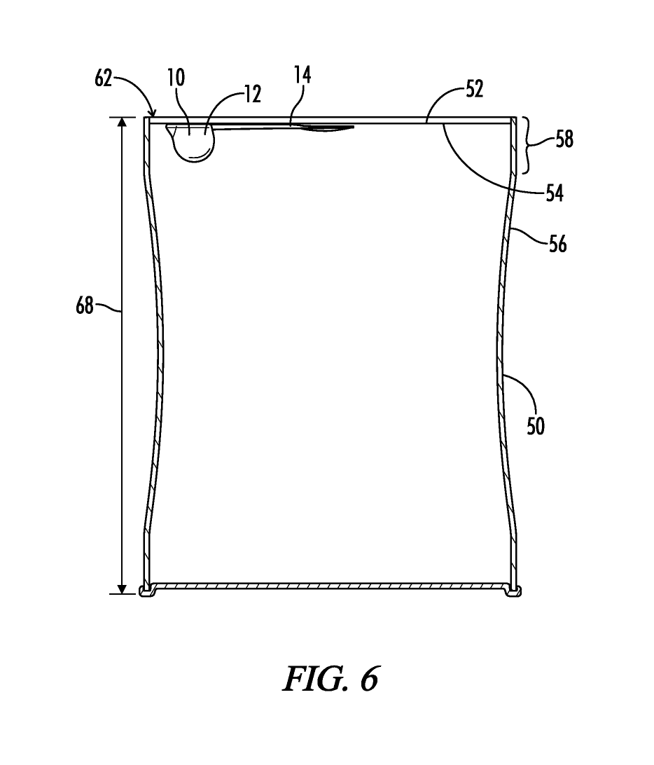

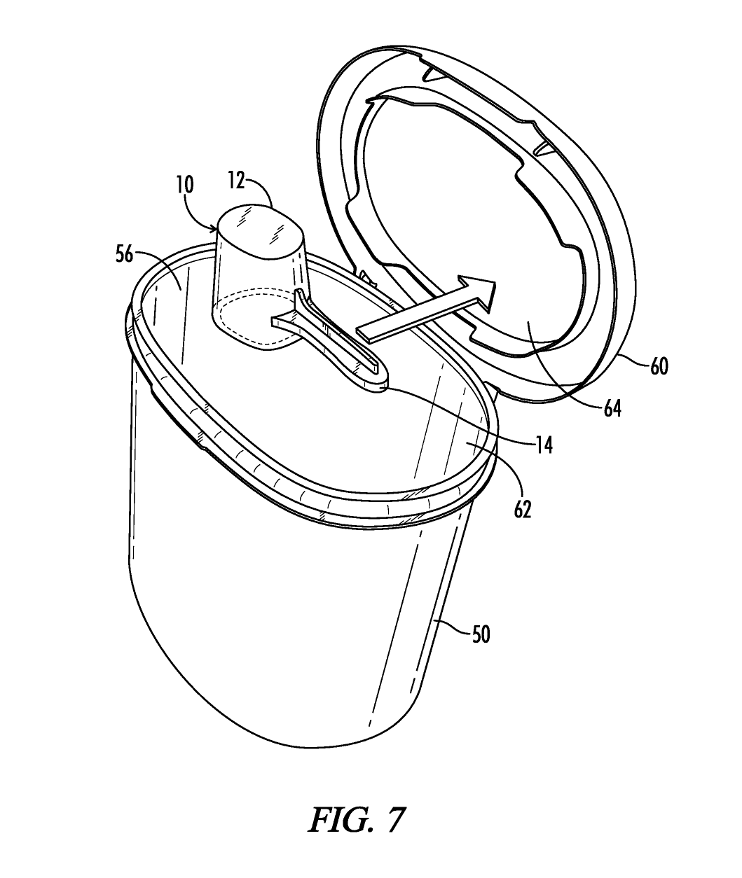

In FIG. 6, scoop 10 is associated with container 50. In an embodiment, container 50 has a metallic foil seal 52 that seals an aperture 62 to preserve freshness of the particulate material stored in container 50. Metallic foil seal 52 may be near the top, or aperture, of container 50. Scoop 10 may magnetically couple with metallic foil seal 52, including magnetically coupling with an underside 54 or a top side 56 of metallic foil seal 52. The magnetic attraction between metallic foil seal 52 and scoop 10 may retain scoop 10 above the particulate material stored in container 50.

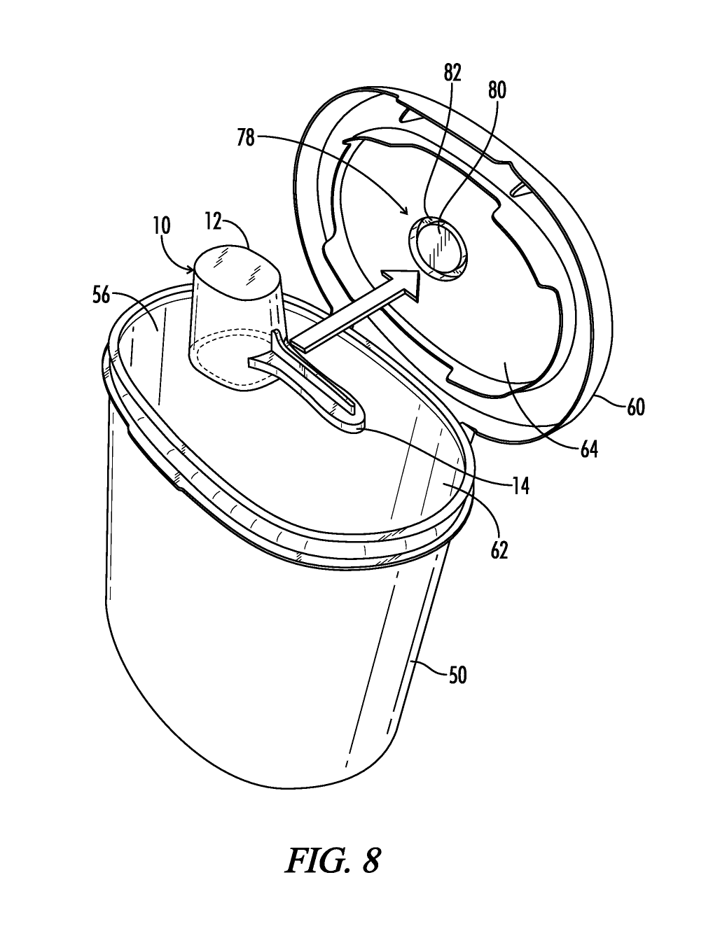

In FIG. 7, scoop 10 is associated with container 50 and closure 60. Closure 60 may seal an aperture 62 in the container 50. Closure 60 may be metallic or formed of an organic polymer having a ferromagnetic powder dispersed therein, as described above with respect to scoop 10. Closure 60 may include an underside 64. Scoop 10 may magnetically couple with underside 64 of metallic closure 60. Magnetic attraction between the metallic closure 60 and scoop 10 can retain scoop 10 above the particulate material held in container 50. Specifically, when an end-user opens and re-opens container 50, scoop 10 may be accessible without the end-user searching through particulate material to locate scoop 10 by being magnetically coupled in location easily accessible to the user. Magnetic recoupling of scoop 10 and closure 60 may increase scoop 10 convenience to the end-user and avoid contamination via product-hand contact.

Moreover, in the embodiments in which scoop 10 is magnetically coupled with sidewall 56 or closure 60, the end-user may also store scoop 10 by magnetically recoupling it to sidewall 56 or closure 60 for reuse.

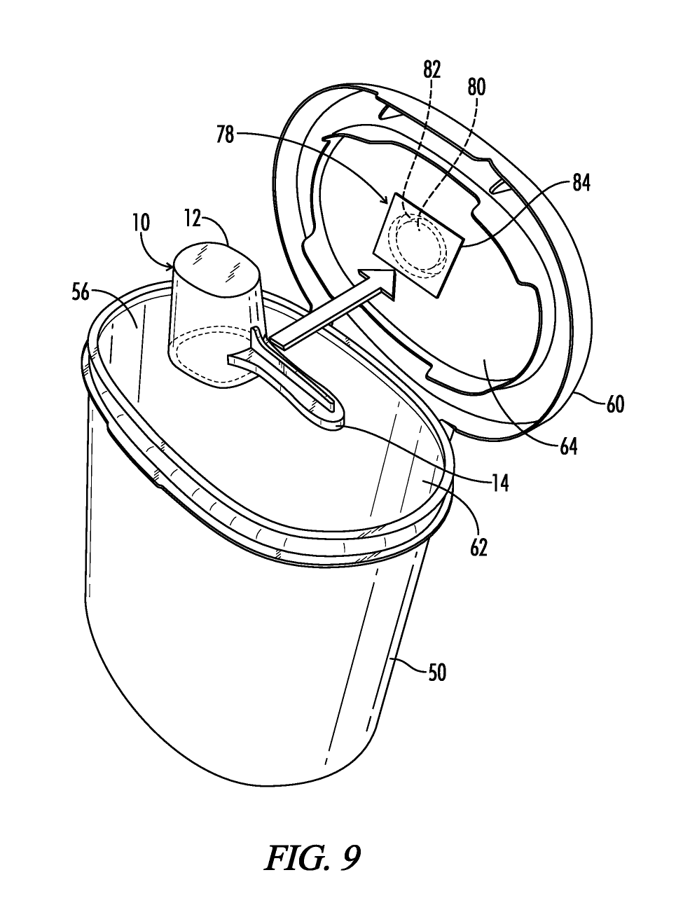

As shown in FIG. 8, scoop 10 may be associated with container 50 and closure 60. In an embodiment, closure 60 includes a magnetic dock 78. Magnetic dock 78 can include a dock magnet 80 disposed therein. Scoop 10 may magnetically couple with dock magnet 80. The magnetic strength of dock magnet 80 may be varied according to weight of the scoop and strength of attraction desired between docket magnet 80 and scoop 10. As measured in magnetic induction, the strength of the magnetic field at the surface of dock magnet 80 may be, for example, between about 1 and about 15 mT. Dock magnet 80 may attract to, pull, and retain scoop 10. In one embodiment, dock magnet 80 may be incorporated into, or integrally formed with, closure 60. In another embodiment, dock magnet 80 may be removably disposed within magnet cavity 82 formed in closure underside 64.

Another embodiment of scoop 10 associated with container 50 and closure 60 is shown in FIG. 9. Magnet cavity 82 can have a film 84 disposed over cavity 82 such that film 84 retains dock magnet 80 within cavity 82. Film 84 may be removable such that dock magnet 80 is retained within magnet cavity 82 until film 84 is removed. Film 84 may be attached to closure underside 64 or at least one cavity edge 88. In an embodiment, film 84 may be removably heat sealed to at least one cavity edge 88 on closure underside 64. Film 84 prevents dock magnet 80 from unintentionally escaping magnet cavity 82 so that dock magnet 82 is not swallowed by a child or does not contaminate product held by container 50. Film 84 may have user instructions printed thereon to indicate to a user to the presence of dock magnet 82 and to instruct the user that film 84 may be peeled away to release dock magnet 80.

In an embodiment including magnetic dock 78, magnetic dock 78 improves user convenience by reducing necessary alignment of scoop 10 and magnetic dock 78 and does not require snapping scoop 10 into magnetic dock 78. Increase ease of coupling and storage of scoop 10 may allow users to couple scoop 10 without looking at scoop 10 or to couple scoop 10 with magnetic dock 78 with one hand. Moreover, the magnetic coupling would occur without a bias towards a left-handed or right-handed user. The coupling of the magnetic dock 78 and scoop 10 may provide a better user experience, as the attraction between the dock magnet 80 and scoop 10 may be perceived by a user as enjoyable.

In an embodiment, dock magnet 80 is removable. After emptying container 50, a user may remove dock magnet 80. Dock magnet 80 may be a souvenir. For example, docket magnet 80 may be adorned with graphics, such as a brand name, logo, and marketing material, or be a collectable. Souvenir dock magnet 80 may be part of a collectable series, for example, three different styles of collectable magnets. Removable dock magnet 80 may create the perception of a premium product to users. In an embodiment, film 84 is opaque, translucent, or has text or a graphic that obscures souvenir dock magnet 80 so that a user has a sense of anticipation while consuming the product and before accessing souvenir dock magnet 80, increasing user satisfaction.

In embodiments including dock magnet 80, scoop 10 may be constructed at least partly of an iron-containing material, such as stainless steel, such that scoop 10 is magnetically attracted to dock magnet 80. The magnetic material may be incorporated into all of or a part of scoop 10. For example, handle 14 may comprise stainless steel.

Scoop 10 includes a docked position 90 and a free position 92. Scoop 10 is in docked position 90 when scoop 10 is magnetically coupled with magnetic dock 78. When scoop 10 is removed from being magnetically coupled with magnetic dock 78, scoop 10 is in free position 92.

Scoop 10 may be operable with a feeding bottle. The feeding bottle may have a larger mouth than outside diameter 20 of scoop 10, so that the positioning of the junction point relative to the top of the bucket allows the user to place the top end of bucket 12 inside the feeding bottle. The engaged bucket 12 and feeding bottle allows bucket 12 to resist lateral sliding forces that would otherwise result in product spillage when the user dispenses product into the feeding bottle from scoop 10.

Although embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. Therefore, the spirit and scope of the appended claims should not be limited to the description of the versions contained therein.

Numerous other objects, advantages and features of the present invention will be readily apparent to those of skill in the art upon a review of the following drawings and description of a preferred embodiment.

Thus, although there have been described particular embodiments of the present invention of a new and useful scoop, it is not intended that such references be construed as limitations upon the scope of this invention except as set forth in the following claims.

1. A scoop for particulate material, comprising,
a bucket and a handle, wherein:
(a) the handle comprises a polymeric material having a ferromagnetic powder admixed therein; or
(b) a band is disposed around the handle, wherein the band comprises a magnetic metallic material and/or at least one ferromagnetic powder or
(c) a spring is disposed on the handle wherein the spring comprises a magnetic metallic material and/or at least one ferromagnetic powder.

2.-3. (canceled)

4. The scoop of claim 1, wherein the at least one ferromagnetic powder comprises ferrite powder, ilmenite powder, neodymium, or a combination thereof.

5. A containment and dispensing system for particulate material, comprising:
a scoop, including:
a bucket and a magnetic handle, wherein the handle comprises a strip magnet thereon or the handle comprises a polymeric material having a ferromagnetic powder admixed therein; and
a container, wherein the scoop is magnetically coupled with the container.

6. (canceled)

7. The containment and dispensing system of claim 5, wherein the container comprises a metallic foil seal, and further wherein the scoop is magnetically coupled with the metallic foil seal.

8. The containment and dispensing system of claim 5, wherein the container comprises a metallic sidewall, and further wherein the scoop is magnetically coupled with the metallic sidewall.

9. The magnetic scoop of claim 1,
wherein the bucket comprises an exterior surface, a diameter, and a tapered tip extending outward from the exterior surface of the bucket in a range of from about 10% to about 30% of the diameter of the bucket.

10. The magnetic scoop of claim 9, wherein the at least one ferromagnetic powder comprises ferrite powder, ilmenite powder, neodymium, or a combination thereof.

11. The magnetic scoop of claim 9, wherein the tapered tip has a profile defined by a circle having a diameter in a range of from 60% to 80% of the bucket diameter.

12. The magnetic scoop of claim 9, wherein the bucket has a depth of from about 75% to about 250% of the diameter of the bucket.

13. The magnetic scoop of claim 9, wherein:
the bucket has a rim defined by a circumference of a top of the bucket; and
the tapered tip curves outward from the rim oppositely from the handle.

14. A scoop and closure apparatus, comprising:
a closure comprising a closure underside;
a magnetic dock disposed on the closure underside, the magnetic dock comprising a removable dock magnet;
a removable film retaining the removable dock magnet on the closure underside;
a scoop comprising a handle, the
scoop comprising at least one ferromagnetic material;
wherein the scoop is in a docked position when it is magnetically coupled with the magnetic dock, and wherein the scoop is in a free position when it is not magnetically coupled with the magnetic dock.

15. The scoop of claim 1, wherein the handle comprises a polymeric material having a ferromagnetic powder admixed therein.

16. The scoop of claim 1, wherein a band is disposed around the handle, wherein the band comprises a magnetic metallic material and/or at least one ferromagnetic powder.

17. The scoop of claim 1, wherein a spring is disposed on the handle wherein the spring comprises a magnetic metallic material and/or at least one ferromagnetic powder.

18. The scoop of claim 5, wherein the strip magnet is oriented along a longitudinal axis of the handle.

19. The scoop of claim 5, wherein the strip magnet is oriented perpendicular to a longitudinal axis of the handle.

20. The scoop and closure system of claim 14, wherein the removable dock magnet comprises a graphic or the removable docket magnet is part of a collectable series.
